(19) United States
(12) Patent Application Publication
(10) Pub. No.: US 2006/0190384 A1
(43) Pub. Date: Aug. 24, 2006

(54) System and method for promoting internet auction listings in public & private venues

(75) Inventors: Steven L. Gurley, Plano, TX (US); Charles H. Ansley, Frisco, TX (US); Todd B. Fleming, McKinney, TX (US)

Correspondence Address: HONEYWELL INTERNATIONAL INC., 101 COLUMBIA ROAD, P O BOX 2245, MORRISTOWN, NJ, 07962-2245, US

(73) Assignee: Symon Communications, Inc.

(21) Appl. No.: 11/239,181

(22) Filed: Sep. 29, 2005

Related U.S. Application Data
(60) Provisional application No. 60/654,610, filed on Feb. 18, 2005.

(51) Int. Cl. G06Q 40/00

(52) U.S. Cl. 705/37

(57) ABSTRACT

According to an embodiment of the invention, a method of promoting an auction item has been provided that includes providing a venue promotion option to a user. The venue promotion option includes a list of venues where information concerning auction listings can be displayed. Instructions are received from the user, which contain a selection of at least one of the venues in which to display information regarding at least one auction listing. The at least one auction listing is listed on a listing page of a website of an auction firm.

### CROSS-REFERENCE TO RELATED APPLICATIONS

Pursuant to 35 U.S.C. § 119 (e), this application claims priority from U.S. Provisional Patent Application Ser. No. 60/654,610, entitled A SYSTEM AND METHOD FOR PROMOTING INTERNET AUCTION LISTINGS IN PUBLIC & PRIVATE VENUES, filed Feb. 18, 2005.

### TECHNICAL FIELD OF INVENTION

This invention relates to the fields of video distribution systems and systems for electronic commerce and more specifically to a system and method for promoting internet auction listings in public and private venues.

### BACKGROUND OF INVENTION

The number of people and businesses selling goods via internet auctions has growing exponentially over the last several years. The success of a seller to maximize the final sale price of an item in an internet auction is largely dependent on the seller's ability to attract the largest possible pool of bidders. It has become increasingly difficult for sellers to attract bidders as the competition for those bidders has increased along with the number of new sellers.

Internet auction firms have recognized this challenge and are providing their sellers with a variety of listing promotion tools, which are predominately fee based, to give those who use these tools an edge in drawing prospective bidders to a given auction. These tools include special listing highlights, the placement of the listing on the auction firm's home page, preferential ranking of the listing on a search page, and preferential placement on other locations within the auction site.

Even though there are a myriad of auction promotion options currently available, sellers, particularly sellers of high value items or those with large portfolios of items, (e.g. auction merchants), need other tools to further differentiate their listings and brands from the thousands of other similar listings and brands.

### SUMMARY OF THE INVENTION

According to an embodiment of the invention, a method of promoting an auction item has been provided that includes providing a venue promotion option to a user. The venue promotion option includes a list of venues where information concerning auction listings can be displayed. Instructions are received from the user, which contain a selection of at least one of the venues in which to display information regarding at least one auction listing. The at least one auction listing is listed on a listing page of a website of an auction firm.

Certain embodiments of the invention may provide numerous technical advantages. For example, a technical advantage of one embodiment may include the capability to provide individuals and merchants who sell goods via internet auctions with the capability to promote their auction listings and/or brands in venues such as restaurants, stores, airports, airplanes, train stations, trains, clubs, cruise liners, bars, hotels, corporate lobbies, corporate break rooms, corporate cafeterias, concert halls, convention centers, restrooms, stadiums, building lobbies, elevators, buildings, and cab stands using electronic video displays. Another technical advantage of another embodiment may include the capability to increase the visibility of an auction listing to a broader audience in order to increases the pool of prospective bidders. Yet another technical advantage of another embodiment may include the capability to increase the seller's prospects for maximizing the value of the final bid and ultimate sale price of their listing. Still yet another technical advantage of another embodiment may include the capability to increase the visibility of the seller's brand—if the seller is an online merchant and desirous of promoting their brand. Still yet another technical advantage of another embodiment may include the capability to provide the auction firm with another listing promotion feature, which will create additional competitive advantage and market differentiation. Still yet another technical advantage of another embodiment may include the capability to provide the auction firm with a mechanism to generate additional listing promotion revenue. Still yet another technical advantage of another embodiment may include the capability to provide the auction firm with additional outlets in which to promote their brand, service offerings, and information. Still yet another technical advantage of another embodiment may include the capability to provide the venue owner with a capability to infuse their own information between or concurrent with the promotion of auction listings. Still yet another technical advantage of another embodiment may include the capability to provide the venue owner with new revenue that is generated from the display of auction listings (and potentially advertisements) in their venue. Still yet another technical advantage of another embodiment may include the capability to provide the venue owner with a continual and dynamic source of content that enhances the value of their infrastructure and customer entertainment. Still yet another technical advantage of another embodiment may include the capability to provide the venue owner with one point of contact to manage all aspects of content delivery to their venue, such as validation, repurposing, and the like.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of example embodiments of the present invention and its advantages, reference is now made to the following description, taken in conjunction with the accompanying drawings, in which:

FIG. 1 depicts a graphical representation of a listing promotion option screen, according to an embodiment of the invention;

FIG. 2 depicts a system that may be utilized to facilitate a communication of information concerning an auction listing to a plurality of displays at a plurality of venues, according to an embodiment of the invention;

FIG. 3 depicts an example flowchart of auction listings, according to an embodiment of the invention;

FIG. 4 depicts a process for preparing an auction listings for display in a venue, according to an embodiment of the invention.;

FIG. 5 depicts an architecture for deploying content to a venue, according to an embodiment of the invention;

FIGS. 6A, 6B, and 6C depict content that may be shown on video displays installed in a plurality of venues, according to embodiments of the invention;

FIG. 7 depicts a process of rotating content on a display, according to an embodiment of the invention;

FIG. 8 depicts methods and devices for bidding on auction listings after viewing a display at a venue, according to an embodiment of the invention; and

FIG. 9 depicts a website, that may allow patrons of a venue to view auction listings displayed within a particular venue, according to an embodiment of the invention.

### DETAILED DESCRIPTION OF EMBODIMENTS OF THE INVENTION

It should be understood at the outset that although example embodiments of the present invention are illustrated below, the present invention may be implemented using any number of techniques, whether currently known or in existence. The present invention should in no way be limited to the example embodiments, drawings, and techniques illustrated below, including the embodiments and implementation illustrated and described herein.

The number of people and businesses selling goods via internet auctions has been growing exponentially over the last several years. The success of a seller to maximize the final sale price of an item in an internet auction is largely dependent on the seller's ability to attract the largest possible pool of bidders. It has become increasingly difficult for sellers to attract bidders as the competition for those bidders has increased along with the number of new sellers.

Internet auction firms have recognized this challenge and are providing their sellers with a variety of listing promotion tools, which are predominately fee based, to give those who use these tools an edge in drawing prospective bidders to a given auction. These tools include the placement of the listing on the auction firm's home page, preferential ranking of the listing on a search page, and preferential placement on the listing on various places within the auction firm's web-site. Even though there are a myriad of auction promotion options currently available, sellers, particularly sellers of high value items or those with large portfolios of items, (e.g. auction merchants), need other tools to further differentiate their listings and brands from the thousands of other similar listings and brands. Accordingly, teachings of some embodiments of the invention recognize an auction listing promotion model that enables sellers to promote their auction listings in venues where people congregate.

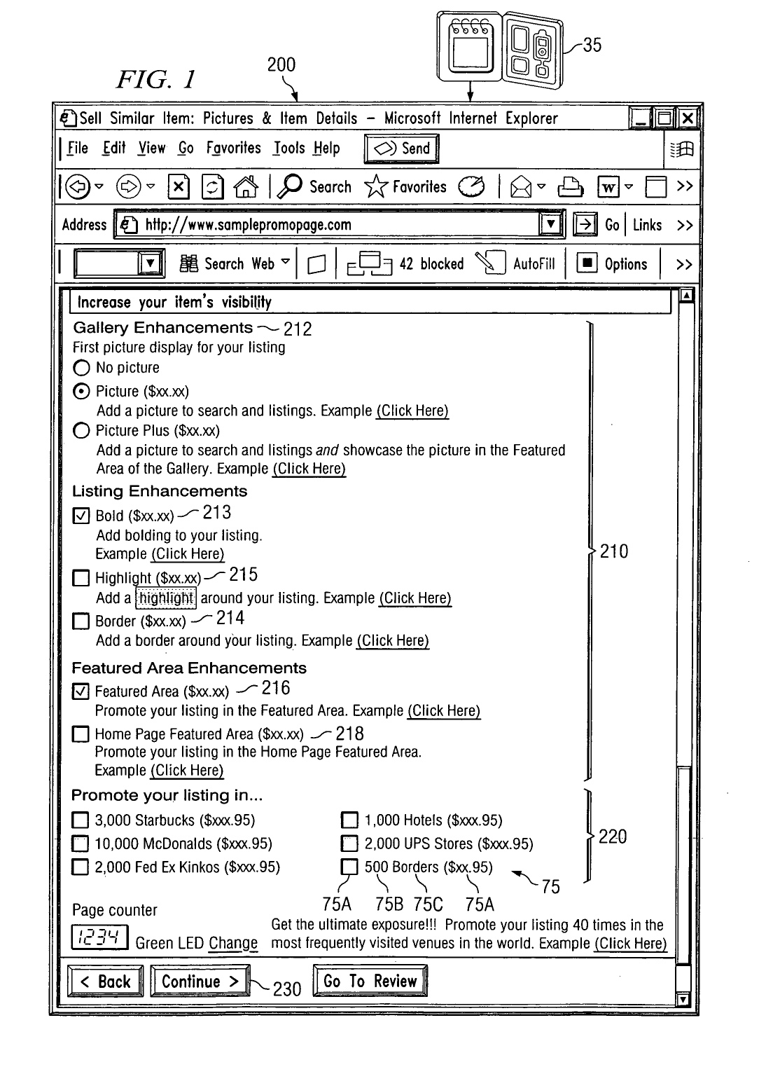

FIG. 1 depicts a graphical representation of a listing promotion option screen 200, according to an embodiment of the invention. When a seller creates an auction listing for an auction item 35, it may generally be desirable to promote the existence of the auction listing. Teachings of embodiments of the invention recognize an auction listing model that opens new channels of communications with potential bidders. These new channels of communication leverage public and/or private venues to increase the awareness of an auction listing. The new channels of communication may additionally enhance a brand awareness for sellers who sell a variety of items under a brand (e.g., merchants). The auction promotion model may additionally facilitate access to the auction listings, thereby increasing the number and subsequent amounts of potential bids. Further details of embodiments of implementation of the auction listing model will be described in greater details below.

According to one embodiment, auction firms (e.g., internet auction firms) or service providers other than the auction firms may provide users with promotion options. As used herein, “user” may generally refer to a person, entity, object or device, capable of selecting items in the promotion options. For example, a user may be an auction seller, merchant, or an individual acting on behalf of an entity to access the promotion options. Alternatively, the user may be a computer, acting on instructions from an entity, organization, or individual to access the promotion option. Options 210 illustrate examples of typical promotion options, which in FIG. 1 include a gallery option 212, a bolding option 213, a border option 214, a highlight option 215, a featured area option 216, and a home page featured option 218. In implementing the new auction listing model, users may be provided with a new promotion option on the promotion option screen 200, a venue promotion option 220. The venue promotion option 220 may allow a user to promote an auction listing in one or more venues or venue groups 75. Venue groups 75 in particular embodiments may be venues grouped according to a common feature between each venue within the group. Examples of common features include, but are not limited to, a type of venue, a geography of the venue, a brand associated with the venue, a class of venue, a variety of specific demographics, or combinations of the preceding. As an example, the venue groups 75 may be a composite of similar venue types such as coffee shops, a specific brand, or a geography or a class of coffee shop. Although venues groups 75 have been shown in the venue promotion option 220 in this embodiment, in other embodiments a user may additionally be given the option to promote a listing in one or more individual venues. Additionally, although venue promotion option 220 has been listed on the same page as options 210 in this embodiment, in other embodiments, the venue promotion option 210 may be listed on a separate page or a separate web site.

In particular embodiments, the venue promotion option 220 may be provided by the auction firm. In other embodiments, the venue promotion option 220 may be provided by parties other than the auction firm, for example, service providers, which are described in greater details below. In embodiments where the venue promotion option 220 is provided by a service provider, the venue promotion option 220 may be provided on a site separate from the auction firm's website. Therefore, the auction firm, itself, may be the user, accessing the venue promotion option 220 to select the venues and/or venue groups 75 to display particular auction items 35. With such embodiments, the auction firms may be seeking to increase brand awareness or advertisement of particular items 35.

In providing the venue promotion option 220, particular embodiments of the invention may utilize logic to suggest venue groups 75 and/or individual venues where a user may be interested in selling a particular auction item 35. For example, such logic may incorporate collaborative filtering or a correlation technique that links an auction item 35 to a venue group 75 or venue. As an example, collaborative filtering logic may suggest popular venues or venue groups 75 selected by other users of similar items. Correlation logic may derive a correlation between a type of the auction item 35 and particular venues and/or venue groups 75. For example, a sports restaurant venue have a high correlation with sports memorabilia auction items. Various other techniques may additionally be utilized to channel the advertisement of the auction listing to an appropriate demographic. To enhance such logic, results obtained from tracking may be utilized as will be described in greater detail below with reference to FIG. 8.

In the embodiment of FIG. 1, six venue groups 75 are depicted in venue promotion option 220: STARBUCKS coffees shops, MCDONALDS restaurants, FED-EX KINKOS stores, hotels, UPS stores, and BORDERS stores. Although these six venue groups 75 have been shown, a variety of other venue groups 75 may be utilized in other embodiments of the invention. As briefly referenced above, such venues or venue groups 75 may include, but are not limited to, restaurants, stores, airports, airplanes, train stations, trains, clubs, cruise liners, bars, hotels, corporate lobbies, corporate break rooms, corporate cafeterias, concert halls, convention centers, restrooms, stadiums, building lobbies, elevators, buildings, theme parks, and cab stands.

A variety of information may be displayed with each venue and/or venue group 75 to allow a user to choose which venues and/or venue groups 75 to advertise the auction listing 35. In the embodiment of FIG. 1, each venue group 75 includes a check box 75A, a number of participating venues 75B, a venue group name 75C, and promotional fees 75D. The check box 75A may allow the user to select one or more venue groups 75 in which to display the auction listing. The number of participating venues 75B may represent the number of venues 70 within the venue group 75. The venue group name 75C may represents the name of the venue group. In particular embodiments, the venue group name 75C may present an indicator of the common feature of the venues within the venue group 75. The promotional fees 75D may represent a fee that will be assessed to the user for promoting the auction listing within the venue group 75. Other embodiments of the venue promotion option 220 may comprise more or less information associated with venues and venue groups 75. Additionally, in other embodiments, a fee may not assessed to the user for choosing a venue promotion option. Rather, in some embodiments, auction firms and/or content providers may bear the cost of the venue promotion option 220.

According to particular embodiments of the invention, the list of venues and/or venue groups 75 may be dynamically updated to reflect new venues and/or venue groups 75. For example, in some embodiments, new venues may be actively recruited to enhance options in the venue promotion option. When new venues are available, the list of venues in the venue promotion option 220 will be updated.

In the embodiment of FIG. 1, once a user has chosen his listing promotion option(s) 210 and/or 220, the user may click the continue button 230 to finalize the listing creation process. Once the listing is finalized and posted by the user to an auction firm's web site, the information associated with the venue promotion option 220 chosen by the user may be collected and communicated to one or more content intermediaries for processing. As described in greater detail below, the content intermediary may apply certain content management techniques, which facilitate communication of the auction listing to a venue.

In other embodiments of the invention, the listing may already be posted and/or resident on the auction firm's web site. A user (e.g., a seller or the auction firm) may decide at some time after the posting of the auction listing but prior to the expiration of the auction to choose to promote the listing in a venue group 75 or venue. In such embodiments, provisions may be made to provide the venue promotion option 220 to the user for selecting a venue or venue group 75 in which to promote the auction item 35 at that time.

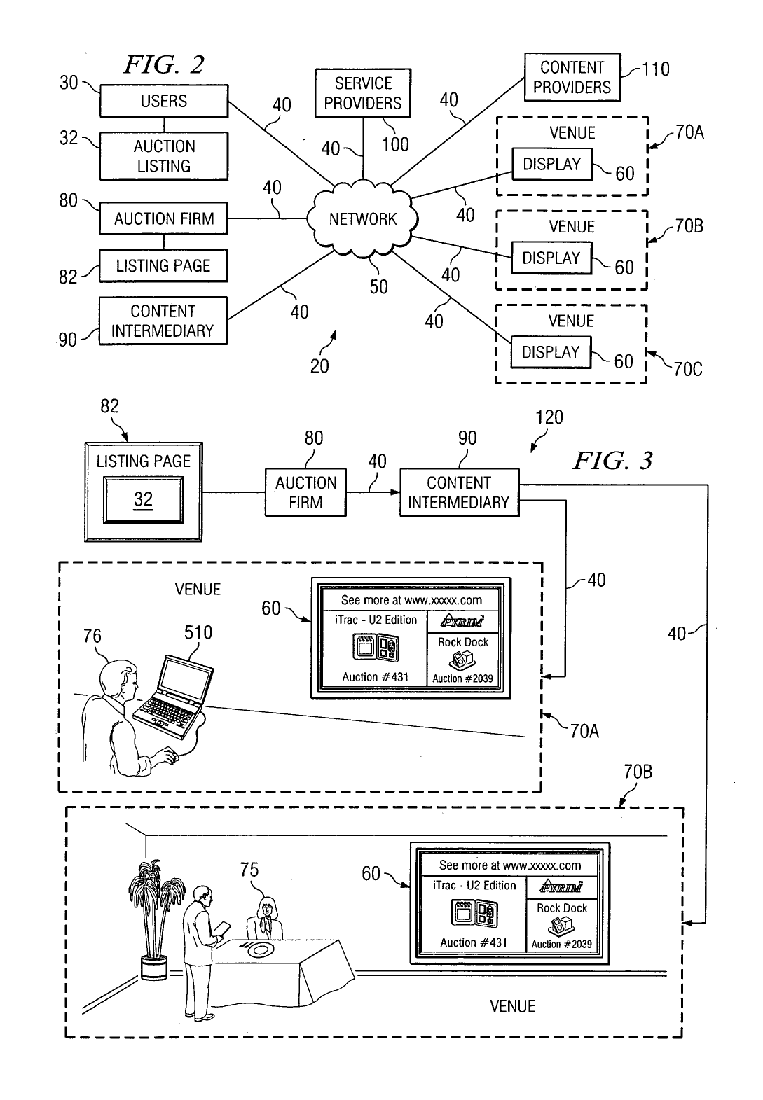

FIG. 2 depicts a system 20 that may be utilized to facilitate a communication of information concerning an auction listing 32 to a plurality of electronic video displays 60 at a plurality of venues 70, according to an embodiment of the invention. FIG. 3 depicts an example flowchart 120 of an auction listings 32, according to an embodiment of the invention. In describing the system 20, reference is made to both FIG. 2 and FIG. 3.

The system 20 in this embodiment includes components that correspond to users 30, an auction firm 80, service providers 100, content providers 110, a content intermediary 90, and venues 70. Each venue 70 may generally host one or more displays 60. The users 30, the auction firm 80, the service providers 100, content providers 110, the content intermediary 90, and venues 70 and/or displays 60 may communicate with one another using communication links 40 and a network 50, both of which are described in greater detail below.

The general architectural configuration of the system 20 may be varied significantly, or alternatively substituted with any suitable components or elements that operate to provide a communicative platform. Further, although specific components are shown in embodiments herein, other embodiments may only utilize some or none of the components shown herein.

Each of the users 30, the auction firm 80, the service providers 100, the content providers 110, the content intermediary 90, the venues 70 and/or the displays 60 may refer to an object, device, software, or any combination of the preceding that is operable to communicate over the communication links 40 and network 50. Examples include, but are not limited to, a computer, a server, or any other device or component of such devices suitable for communicating information to and from the communication links 40 and/or the network 50. In some embodiments the users 30, the auction firm 80, the service providers 100, the content providers 110, the content intermediary 90, the venues 70 and/or the displays 60 may correspond to a user and/or users who use such components to communicate information through the communication links 40 and/or network 50. For example, the users 30 may correspond to users who creates auction listings 32, which are communicated to the auction firm 80 for posting on a listing page 82, which may, for example, be stored on a server associated with the auction firm 80. The users 30, the auction firm 80, the service providers 100, the content providers 110, the content intermediary 90, the venues 70 and/or the displays 60 in some embodiments may support Internet Protocol (IP) or other suitable communication protocols.

The communication link 40 and network 50 facilitate communication among the various components of the system 20. The communication links 40 and network 50, alone or in combination with one another, may comprise all or a portion of a public switched telephone network (PSTN); a public or private data network; a local area network (LAN); a metropolitan area network (MAN); a wide area network (WAN); a global computer network such as the Internet; a wireline or wireless network; a local, regional, or global communication network; a satellite network; an enterprise intranet; other suitable communication links; or any combination of the preceding.

As briefly referenced above, the auction firm 80 in particular embodiments may host auction listings 32 on listing pages 82. As an example, the listing page 82 may be stored on a server (local or remote), controlled by the auction firm 80. The listing page 82 is where bidders may evaluate the auction item being auctioned in the auction listing 32 and where the bidders may be capable of placing their bids on the auction listing 32. As an example, the listing page 82 may be accessible through a web site of the auction firm 80 or through other appropriate means of access.

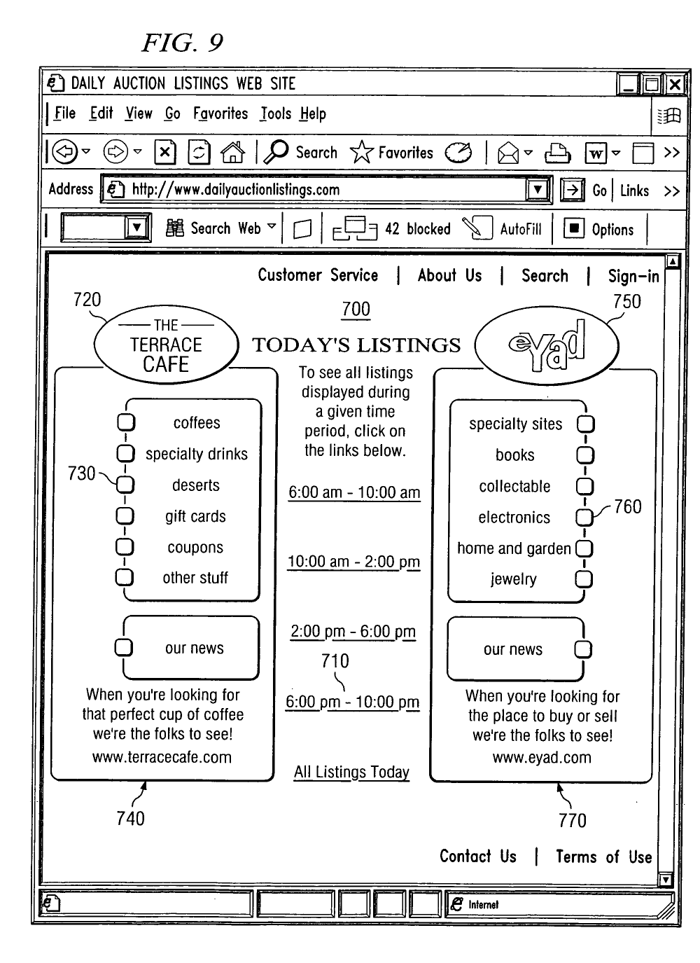

According to particular embodiments, the auction firm 80 may provide the venue promotion option 220 to the auction firm's portfolio of listing promotion tools. Although not explicitly shown in FIG. 1, the auction firm 80 may also allow merchants to include logos in the display of their auction listing 32. The auction firm 80 may also add logos of participating venues 70 or venue group 75 to a web home page of the auction firm 80 and link these logos to the appropriate web page of a daily venue listing web site, described in further details below with reference to FIG. 9.

Although the auction firm 80 has been described as being involved with a venue promotion, in other embodiments, the service providers 100 may provide such a venue promotion option for auction listing 32, for example, separate from services provide by the auction firm 80. In such embodiments, users 30 (including the auction firm 80, itself) may register with the service provider 100, providing information about a previously created auction listing 32 on a listing page 82. The service provider 100 may then use this information to promote the auction listing 32 on displays 60 in venues 70. For purposes of simplicity, description below will describe an embodiment in which the auction firm 80 is involved with the promotion of the auction listing 32 on the listing page 82. However, teachings of embodiments of the invention should not be construed to be limited to this or any other disclosed embodiment.

With reference to FIGS. 2 and 3, once a user 30 chooses to promote an auction listing 32 and associated listing page 82 with one or more venues 70 and/or venue groups 75, the auction firm 80 or service provider 100 may communicate information about the auction listing 32 and associated listing page 82 (e.g. the listing title, start dates, end dates, pictures, logos, etc.), to a content intermediary 90 for processing. As briefly described above, in particular embodiments the auction firm 80 or the service providers 100 may assess the user 30 a fee for promoting the auction listing 32 and associated listing page 82 in one or more venue groups 75 and/or individual venues 70. Accordingly, the auction firm 80 or service provider 100 may include in their process a mechanism for accommodating refunds if the auction listings 32 are rejected due to a violation of prescribed policies and practices or if the auction listing 32 is not displayed properly in the selected venues 70.

In some embodiments, the content intermediary 90 may be local and/or part of the auction firm 80 or the service provider 100. In other embodiments, the content intermediary 90 may be a distance and/or separate from the auction firm 80 or service provider 100. Therefore, the communication link 40 between the two may correspond, accordingly.

In particular embodiments, the auction listing 32 and associated information may be reformatted or combined with other content before being transmitted to the displays 60. Details of some of such embodiments will be described below, for example, with reference to processing by the content intermediary 90.

The content intermediary 90 may provide a variety of content management functions, according to particular embodiments of the invention. For example, the content intermediary 90 may acquire and administer content policies and practices imposed by the auction firms 80, owners of the venues 70, service providers 100, or content providers 110. These content policies and practices may include, but are not limited to, the type of auction listings 32 and associated content that can be displayed, the format of the auction listing 32 and associated content, and the rules for development and integration of content from the venue 70 and/or content providers 110. The content intermediary 90 may additionally process the auction listing 32 for delivery to displays 60 at venues 70. In describing the processing 400 of an auction listing 32 by the content intermediary 90, reference is made to FIGS. 2, 3, and 4.

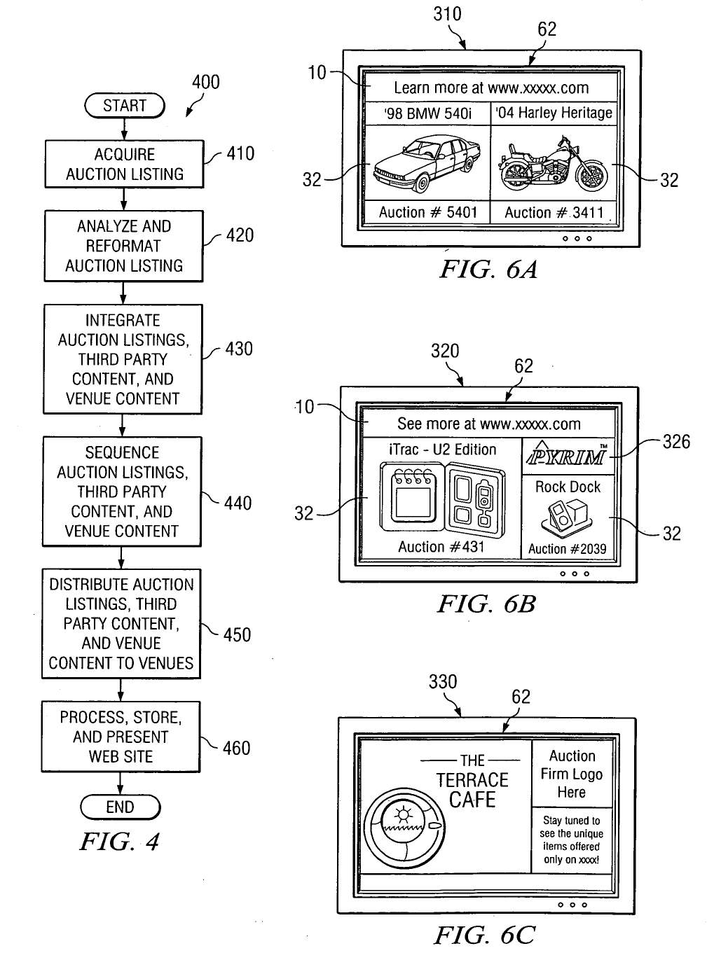

FIG. 4 depicts a process 400 for preparing an auction listings 32 for display in a venue 70, according to an embodiment of the invention. The process 400 may begin at step 410 with the content intermediary 90 acquiring the auction listings 32. The auction listing 32 may include, but is not limited to, listing titles, start dates and times, end dates and times, and pictures. As briefly described above, in particular embodiments the auction listing 32 may be received from the auction firm 80 or service providers 100.

The process 400 may then proceed to step 420 where the content intermediary 90 analyzes and reformats auction listings 32 and associated information according to requirements and specifications that may be imposed by the electronic video electronic video display 60, auction firm 80, service providers 100, and/or particular venue 70.

The process 400 may then proceed to step 430 where the content intermediary 90 integrates venue content and third party content from content provider 110 with the auction listings 32. In such integration, particular embodiments may reformat the venue content and third party content from content provider 110 in a similar manner to the reformatting of the auction listings 32, for example, to conform to requirements and specifications that may be imposed by the electronic video display 60 and/or particular venue 70. After such integration, the content may be sequenced for display at step 440. The sequencing may define the order in which the auction listings 32, the venue content, and the third party content from content provider 110 will be displayed along with the time length of the display of the auction listings 32, venue content, and the third party content from content provider 110.

The process 400 may then proceed to step 450 where the auctions listings 32, the venue content, and the third party content from content provider 110 are distributed to the appropriate displays 60 in the appropriate venues 70. If content can not be displayed due to violations of content policies and practices or technical errors, the content intermediary 90 may notify the auction firm 80 or service provider 100.

Upon distribution of the auctions listings 32, the venue content, and the third party content from content provider 110, the process 400 may proceed to step 460 where the content intermediary 90 processes, stores, and presents a web site that may display, by particular venue 70, the auction listings 32 displayed during selected hours of a given day. This site may maintain hot links to the appropriate listing page 82 maintained at the auction firm 80. The web site may also be accessible via a web site of the particular venue 70 or a web site of the auction firm 80 or the service provider 100, for example, through a linked logo for each participating venue 70. The web site may additionally have its own unique URL. Further details of an embodiment of a web site, which may be created by content intermediary is described below with reference to FIG. 9.

With reference back to FIGS. 2 and 3, the content intermediary 90 may additionally provide a call center to answer questions from users about the display process and to provide a help desk support for the auction firms 80, venues 70 and third parties 100. The content intermediary 90 in particular embodiments may additionally provide billing services to the auction firms 80, venues 70 and third parties 100.

Although various content management functions have been described above with reference to content intermediary 90, several of such content management functions may be provided by other components, for example, the auction firm 80, the venues 70, or the service providers 100. For example, as described with reference to FIG. 8, venue content may be provided at the venue 70. Additionally, the service provider 100 may provide the web site referenced above in step 460 of FIG. 4.

With reference to FIG. 2, the content providers 110 may correspond to advertisers or other content providers who seek to provide content to be displayed at the venues 70. In particular embodiments, the content providers 110 may provide content including, but not limited to news, advertisements, entertainment and other appropriate information for display on the displays 60 in addition to the auction listings 32. In some embodiments, the content providers 110 may pay the owners of the venues 70, the content intermediary 90, the service providers 100, and/or auction firm 80 to display advertisements on the electronic video electronic video display 60. In other embodiments, the owners of the venues 70, the content intermediary 90, the service providers 100 and/or auction firm 80 may pay the content providers 110 for news and/or entertainment displayed on the displays 60. In particular embodiments, the content from the content providers 110 may be transmitted to the content intermediary 90 for integration with the auction listings 32 and content from venues 70.

The venues 70 may include any of a variety of locations operable to host a electronic video electronic video display 60. For purposes of illustration, the venues 70 have been shown as three different venues 70A, 70B, and 70C. Once again, examples of venues include, but are not limited to restaurants, stores, airports, airplanes, train stations, trains, clubs, cruise liners, bars, hotels, corporate lobbies, corporate break rooms, corporate cafeterias, concert halls, convention centers, restrooms stadiums, building lobbies, elevators, buildings, and cab stands. In particular embodiments, the system 20 may take advantage of an existing communication infrastructure existing at particular venues 70 as part of the communication links 40 and/or network 50. For example, particular venues 70 may have established wired (e.g., Ethernet LAN, video, or other wired technology) or wireless (e.g., wireless “hot spots”, 802.11 access points or other wireless communications) access.

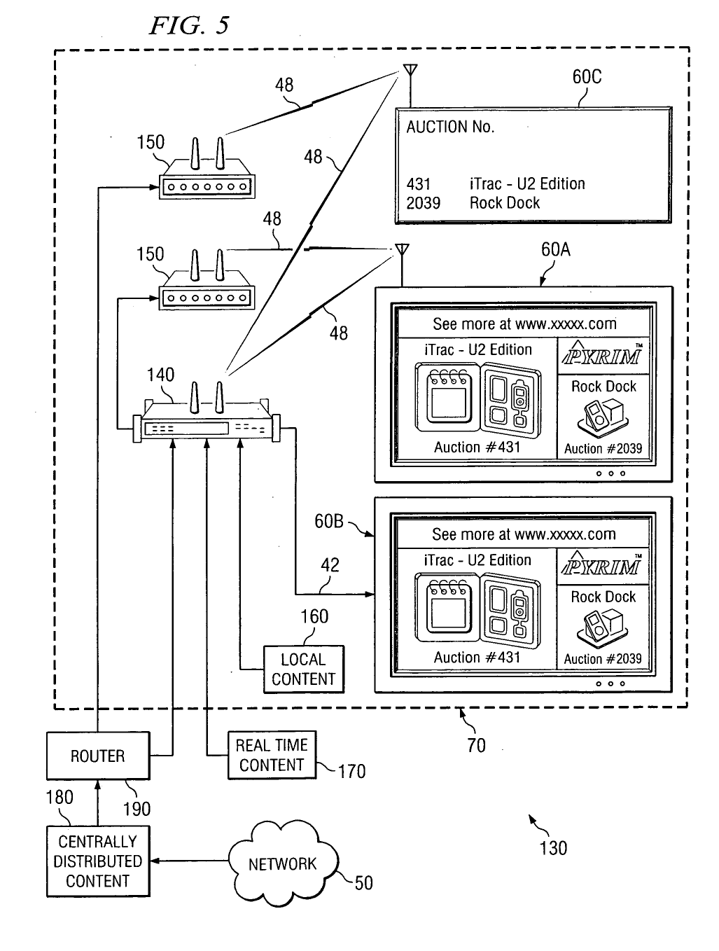

The displays 60 may comprise any of variety of platforms upon which auctions listings 32 and/or other information may be displayed to patrons of the venues 70. Each venue 70 may have one or more displays 60 installed. The displays 60 may be mounted inside the venue 70, outside the venue 70 or combinations thereof. In particular embodiments, the displays 60 may be electronic video displays. In such embodiments, the electronic video displays may comprise any video display technology capable of projecting dynamic and static video images, graphics, etc. suitable for a particular venue 70. Examples of electronic video display technologies include, but are not limited to, CRT, DLP, LCD, LED, and plasma technologies implemented on a television, a monitor, or a projector. In particular embodiments the displays 60 may support wired network connections or wireless network connections. The displays 60 may be connected to a video tuner, video controller or may be connected directly to a network. In particular embodiments, the type and/or configuration of the displays 60 may be dependent on the venue 70 in which the displays will be mounted. Further details of an embodiment of an architecture of displays 60 at a venue 70 are described with reference to FIG. 5.

As briefly introduced above, content on the electronic video display 60 may include, but is not limited to the auction listings 32, content from the content providers 110 (e.g., advertisements, news, or entertainment), and content from venues 70. In particular embodiments, the content from venues 70 may be relayed to the content intermediaries 90 for integration with the auction listings 32 and the content from the content providers 110. In other embodiments, the content from the venues 70 may be integrated at the venue 70, for example, as described with reference to FIG. 5.

As seen in FIG. 3, patrons 75 at venues 70A, 70B may view the displays 60. The patron 70A may have access to a laptop 510 to bid upon an auction listing 32 that may be displayed on displays 60. Further details of bidding will be described below with reference to FIG. 8.

FIG. 5 depicts an architecture 130 for deploying content to a venue 70, according to an embodiment of the invention. In particular embodiments, the venues 70 may be distributed at various geographic locations nationwide, facilitating concurrent display of various auction listings 32. Architectures, similar or different than architecture 130, may be employed in each of the plurality of venues 70 distributed nationwide. Therefore, the architecture 130 may be varied significantly, or alternatively substituted with any suitable networking components or elements that operate to provide a communicative platform between the network 50 and the displays 60.

The architecture 130 of FIG. 5 includes a video controller 140, wireless access points 150, wireless electronic video display 60A, wired electronic video display 60B, and an LED display 60C. The video controller 140 in some embodiments may comprise a personal computer, server, or other system hardware dedicated to video management functions. The video controller 140 may receive input from a variety of sources. In this embodiment, the video controller 140 receives local content 160, real-time content 170, and centrally distributed content 180. The local content 160 may generally be locally prepared content (e.g., venue logos or venue event information) and the real-time content 170 may be video feed, for example concerning news, weather or the like. The centrally distributed content 180 may be content received from the content intermediary 90, service provider 100, or content provider 110.

The video controller 140 in particular embodiment may enable the owner of a venue 70 to integrate the local content 160 and real time content 170 with the centrally distributed content 180. The video controller 140 may also facilitate the distribution of different content to different displays 60, which in FIG. 5 are shown as a wireless electronic video display 60A, a wired electronic video display 60B, and an LED display 60C. As an example, the video controller 140 may allow auction listings 32 to be channeled to one electronic video display 60 while national/international news and weather are channeled to another. In particular embodiments, the video controller 140 may be a Symon Digital Appliance™ (SDA) series video controller, commercially available from Symon Communications.

In routing the content to the various displays 60, the architecture 130 may include a variety of networks interface, recognized by those or ordinary skill in the art. For example, the architecture may utilize a switch for connecting the various local-area network components, (e.g. wired ETHERNET connections to the video controller 140 and a wireless access point 150) and an IP Router 190 for connecting a local-area network of the venue 70 to the communication link 40 and/or network 50. The network interface may also comprise modems for bridging routers to the communication link 40 and/or network 50.

The video displays 60 may include, but are not limited to, any of the variety of types of displays 60 described above with reference to FIG. 2. For purposes of illustration, the video displays 60 in FIG. 5 are shown as a wireless electronic video display 60A, a wired electronic video display 60B, and an LED display 60C. In delivering content to the displays, the content may be routed either through the video controller 140 or directly to the video displays 60. The content may ultimately be communicated to the video displays 60 using a wireline 42 or wireless 48 connection. To facilitate wireless transport to the displays, FIG. 5 shows wireless access points 150, which are recognized by those of ordinary skill in the art. In particular embodiments the wireless access points 150 may utilize appropriate protocols to transport content wirelessly. In particular embodiments, the content may be communicated wirelessly directly from the video controller 140 to the displays.

FIGS. 6A, 6B, and 6C depict content that may be shown on video displays 60 installed in the plurality of venues 70, according to embodiments of the invention. FIG. 6A shows an individual seller listing 310; FIG. 6B shows a merchant listing 320; and FIG. 6C shows venue/third party content 330. Although descriptions of particular organizations and types of content will be described with some embodiments, other embodiments may have different types of content and/or organization. For example, other embodiments may include general advertisements for commercial goods.

A display portion 62 in the individual seller listing 310 of FIG. 6A may depict the auction listings 32 provided by individuals selling goods via an internet auction. In particular embodiments, these auction listings 32 may comprise high value items whereby the seller is willing to pay a premium for maximum exposure. The items depicted in FIG. 6A include an expensive luxury sedan and a high priced motorcycle. Other items that individuals may wish to promote may include, but are not limited to, one-of-a-kind collectables, jewelry, houses, etc. The display portion 62 also includes information 10 to facilitate a buyer's ability to bid on the items in the auction listings 32. The information 10 in FIG. 6A is a web address; however, in other embodiments, the information 10 may be a phone number or a code. FIG. 6A depicts two auction listings 32 displayed concurrently. The auction firm 80 and owner of the venue 70 in which the electronic video display 60 is located may prescribe how many auction listing 32 may be listed concurrently and/or the organization of elements portrayed on the screen.

The display portion 62 of the merchant listing 320 of FIG. 6B may be content provided by merchants. These merchants may use the display portions 62 of the displays 60 to raise brand awareness of the merchant as well as display auction listings 32. The merchant listing 320 may include, but is not limited to auction listings 32, the merchant's/seller's logo 326, a description of the seller's business (not explicitly seen), and information 10 to facilitate a buyer's ability to visit the merchant and/or the merchant's auction listings 32.

The display portion 62 of the venue/third party content 330 of FIG. 6C may be content that an owner of a venue 70 and/or content provider 110 wish patrons to view. In particular embodiments, this content may be supplied to a content intermediary 90. In other embodiments, the content may be incorporated locally, for example, by the video controller 140 described above with reference to FIG. 5. According to particular embodiments, the venue/third party content 330 may be interspersed between exhibitions of merchant listings 320 and individual seller listings 310. The venue/third party content 330 may include, but is not be limited to, logos, product information, advertisements product promotions, entertainment, local news, and the like. In particular embodiments, owners of the venue 70 may sell space to content providers 110 for advertising.

In the depicted embodiments of the individual seller listing 310 and the merchant listings 320, actual pictures of the items are shown as may be extracted from the auction listings 32 and presented on the displays 60. Other embodiments of the invention may use only the title of the auction listing 32 or may use a generic graphic which best depicts the item(s) being auctioned.

According to particular embodiments of the invention, the time and date in which an auction listings 32 will be displayed may be prescribed by the ending date and time of the auction. For example, the listings may automatically commence to be displayed on the last day of the auction and begin a display rotation at least four hours prior to the end of the auction. Other embodiments may contemplate different start times. In particular embodiments, the remaining time in the auction may additionally be displayed in the display portion 62.

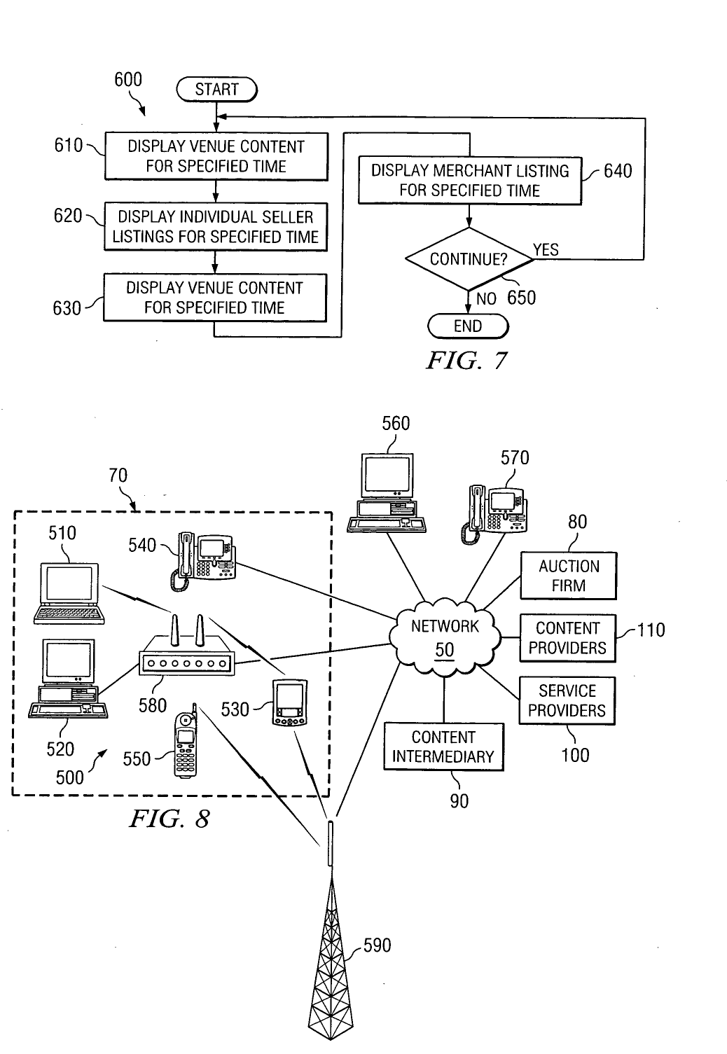

FIG. 7 depicts a process 600 of rotating content on a electronic video display 60, according to an embodiment of the invention. The process 600 may begin at step 610 with venue content 330 being displayed for a specified time. As an example, in particular embodiments the venue content 330 may be displayed for four seconds. After displaying the venue content 330, the process 600 may display individual seller listings 310 for a specified time at step 620. As an example, in particular embodiments the individual seller listings 310 may be displayed for ten seconds. After displaying the individual seller listings 310, the process 600 may display venue content 330, once again, for a specified time at step 630. As an example, in particular embodiments the venue content 330 at step 630 may be displayed for six seconds. The process 600 may then display merchant listings 320 for a specified time at step 640. As an example, in particular embodiments the merchant listings 320 at step 640 may be displayed for ten seconds. At decisional step 650, a determination can be made to continue the process 600. If the process 600 is continued, the process 600 may loop back to step 610, repeating steps 610 through 640. If the process 600 is not continued, the process 600 may be terminated at step 650.

Through various loops of the process, the content may be changing. For example, a particular loop may display certain auction listings 32 while a subsequent loop will display different auction listings 32. Although the example process 600 of rotating content has been described above with reference to one embodiment, other embodiments may utilize a variety of other rotating techniques with different times, different orders, and different types of content. The teachings of the present invention are not limited to any specific rotation schedule. The rotation schedule and duration of display in some embodiments may be determined by the requirements of the auction firm 80, service providers 100, content providers 110, and/or the owners of the venue 70.

These display portions 62 on these various listings provide a viewer with changing content, which may be a source of entertainment while waiting for service, checkout, etc. These display portions 62 may additionally provide the viewer with a source of information, concerning either the venue or news of the day. Additionally the display portions 62 may provide an awareness of a particular item for which they may have a need or a desire, that is being sold via an internet auction.

FIG. 8 depicts methods and devices for bidding on auction listings 32 after viewing a electronic video display 60 at a venue 70, according to an embodiment of the invention. After viewing a electronic video display 60 with display content 62 corresponding to an auction listing 32, individuals may have the opportunity to bid on the auction listings 32 either at the venue 70 or away from the venue 70. As briefly referenced above, the display portion 62 of the electronic video display 60 may have information 10 that an individual may utilize to locate and bid on a particular item, corresponding to an auction listing 32. In particular embodiments, this information may be linked to the particular venue 70, using a variety of tags, to facilitate a tracking for auction listings 32 viewed at a particular venue 70. For example, the same auction listing 32, being displayed at two different venues 70, may have different information 10 (e.g,. an auction item number), the information 10 corresponding to the particular venue 70. As briefly referenced above, the tracking may be utilized to facilitate logic in suggesting venues in the venue promotion option 220 described with reference to FIG. 1.

In other embodiments, for example, the embodiment described with reference to FIG. 9, an individual may utilize a website 700 which displays auction listings 32 according to a particular venue 70 and/or time the auction listing 32 was shown.

The devices shown in the embodiment of FIG. 8 include a laptop computer 510, a computer 520, a personal digital assistant 530, a telephone 540, and a mobile phone 550. In particular embodiments, a patron may bid from his own laptop computer 510 or a computer 520 provided by the venue 70 as a kiosk to bid on and/or view auction listings 32. In embodiments in which a patron brings his own laptop computer to the venue 70, the venue 70 may provide free limited wireless Internet access that is limited to only portions of the Internet applicable for viewing and/or bidding on the auction listing 32. In particular embodiments, the free Internet access may default to a designated home page desired by the venue 70, for example, one of the web page 700 described below with reference to FIG. 9. Such configurations, for example, may be used in wireless “hot spots” where patrons must either pay for Internet access or have a “hot spot” account to acquire Internet access. As an example, intended for illustrative purpose only, a patron may be given free limited Internet access at a hotel, on an airplane, on a cruise ship, at an airport, or at a coffee shop. A similar free limited Internet access feature may similarly be utilized in allowing a person to bid from personal digital assistants 530 equipped with wireless capabilities. In particular embodiments, the free limited Internet access may be the primary method of communicating an auction listing 32 to patrons at a particular venue 70.

The computers 520 may serve as a kiosk with access to viewing and/or bidding on auction listings 32. Similar to that described above, a patron of the venue 70 may be given free limited Internet access to only portions of the Internet applicable for viewing and/or bidding on the auction listing 32.

With either the phone 540 or the mobile phone 550, a patron may call in a bid through a base station 590 connected to the network 50. The phone call may utilize communications with a customer service representative, voice recognition, or Dual Tone Multi-Frequency Tones (DTMF) recognizable by a processor to place the bid. In mobile phones 550, the bid may additionally be entered using any features available on the phone, for example, short message service (SMS), email or Internet access. The patron may similarly bid using Internet access that may be available on the personal digital assistants 530 through the base station 590. In any of these bids, the patrons in particular embodiments may use the information 10 provided in the display of the auction listing 32.

In particular embodiments, the content displayed on the displays 60 may also be displayed on the devices. In bidding on the auction listings 32, various embodiments may utilize the bidding resources of the auction firm 80, for example, to receive the bids. In other embodiments, the content intermediary 90 and/or service providers 100 may receive bids for submittal to the auction firm 80.

In particular embodiments, a patron may bid at a location remote from the venue 70. In such embodiments, the patron may access the viewed auction listing 32 using information 10 provided and/or a website 700, described with reference to FIG. 9.

FIG. 9 depicts a website 700, that may allow patrons of a venue 70 to view auction listings 32 displayed within a particular venue 70, according to an embodiment of the invention. The web site 700 in the embodiment of FIG. 9 provides access to all the auction listings 32 exhibited on a particular day for a particular venue 70. According to embodiments of the invention, the web site 700 may be accessible via a web site of the venue 70, a web site of the auction firm 80, and/or via a unique URL, which will can be displayed with each auction listing in information 10. The home page of the web site 700 may either present a picture of every listing shown on a given day or link to other page(s) that show the auction listings 32. In FIG. 9, the auction listings 32 are grouped by time periods 710 in which they were displayed. In particular embodiments, each listing picture or description can link a patron (e.g. via URL Hot Link) to the listing page 82 hosted by the auction firm 80.

The web site 700 may be particularly useful for patrons that do not have immediate access to a device to enter or view auction listings 32. With website 700, patrons of a venue 70 may only need to remember the venue 70 they visited and the date. Through the web site 700, the patron can then also have access to all auction listings 32 for the particular venue 70—even those presented at a time different than that of their visit. Using the web site, the patron can then view auction listings 32 in a logical, user-friendly layout.

The web site 700 may additionally provide brand exposure for both the owner of the venue 70 and the auction firm 80. As seen in FIG. 9, the website 700 includes venue logo 720, venue links 730, venue web page link 740, auction firm logo 750, auction firm links 760, and an auction firm web page link 770. The web site may additionally provide a mechanism for follow-on visits to the venue 70 via the sale of gift cards or the promotion of coupons, a mechanism for generating exposure to other auction listings 32 or promotions of the auction firm 80, a mechanism for creating a conduit to the respective web sites of the owner of the venue 70 and the auction firm 80, and a mechanism for selling and displaying online advertisements.

Although the present invention has been described with several embodiments, a myriad of changes, variations, alterations, transformations, and modifications may be suggested to one skilled in the art, and it is intended that the present invention encompass such changes, variations, alterations, transformation, and modifications as they fall within the scope of the appended claims.

What is claimed is:

1. A method of promoting an auction item, the method comprising:
providing a venue promotion option to a user, the venue promotion option including a list of venues where information concerning internet auction listings can be displayed;
receiving instructions from the user, the instructions containing a selection of at least one of the venues in which to display information regarding at least one auction listing, the at least one auction listing listed on a listing page of a website of an auction firm;
formatting the information regarding the at least one auction listing for display at the at least one of the venues; and
communicating the information regarding the at least one auction listing to the at least one of the venues through a communication network for displaying on an electronic video display at the at least one of the venues.

2. The method of claim 1, further comprising:
displaying the information regarding the at least one auction listing to patrons of the at least one of the venues who did not request to view the information regarding the at least one auction listing.

3. The method of claim 1, wherein the information regarding the at least one auction listing is received at the at least one of the venues from the communication network by a video controller, further comprising:
communicating the information regarding the at least one auction listing from the video controller to the electronic video display, wherein at least a portion of the communication is wireless.

4. The method of claim 1, the method further comprising:
providing a website which contains the information regarding the at least one auction listing displayed at the venue during a particular time period.

5. The method of claim 4, wherein the time period is a day.

6. A method of promoting an auction item, the method comprising:
providing a venue promotion option to a user, the venue promotion option including a list of venues where information concerning auction listings can be displayed; and
receiving instructions from the user, the instructions containing a selection of at least one of the venues in which to display information regarding at least one auction listing, the at least one auction listing listed on a listing page of a website of an auction firm.

7. The method of claim 6, wherein the user is an auction seller.

8. The method of claim 6, wherein the user is the auction firm.

9. The method of claim 6, wherein the user is a merchant.

10. The method of claim 6, wherein the at least one of the venues is selected from the group consisting of restaurants, stores, airports, airplanes, train stations, trains, clubs, cruise liners, bars, hotels, corporate lobbies, corporate break rooms, corporate cafeterias, concert halls, convention centers, restrooms, stadiums, building lobbies, elevators, buildings, and cab stands.

11. The method of claim 6, wherein
the list of venues are grouped into venue groups, according to a common feature amongst the venues in a venue group; and
the instructions contain a selection of at least one venue group in which to display information regarding the at least one auction listing.

12. The method of claim 6, wherein providing a venue promotion option to the user and receiving instructions from the user are carried out by the auction firm.

13. The method of claim 6, wherein providing a venue promotion option to a user and receiving instructions from the user are carried out by a service provider other than the auction firm.

14. The method of claim 6, wherein the venue promotion option is provided on the website of the auction firm.

15. The method of claim 6, wherein the venue promotion option is hosted on a website of a service provider other than the auction firm.

16. The method of claim 6, further comprising:
dynamically updating the list of venues.

17. The method of claim 6, wherein providing the venue promotion option to a user includes utilizing logic to suggest venues where the user may be interested in displaying the information regarding the at least one auction listing, the logic generating the list of venues according to the information regarding the at least one auction listing.

18. The method of claim 17, wherein the logic utilizes a correlation between the information regarding the at least one auction listing and information regarding the venues.

19. The method of claim 17, wherein the logic utilizes results obtained from tracking of information regarding auction listings previously displayed in venues.

20. The method of claim 6, further comprising:
formatting the information regarding the at least one auction listing for display at the at least one of the venues.

21. The method of claim 20, further comprising:
communicating the information regarding the at least one auction listing to the at least one of the venues through a communication network for displaying at the at least one of the venues.

22. A method of promoting an auction item, the method comprising:
receiving, at a venue where people congregate, information regarding at least one auction listing from a communication network, the at least one auction listing listed on a listing page of a website of an auction firm; and
displaying the information regarding the at least one auction listing to at least one patron of the venue who did not request to view the information regarding the at least one auction listing.

23. The method of claim 22, wherein displaying the information regarding the at least one auction listing is carried out on an electronic video display.

24. The method of claim 22, further comprising:
providing a venue promotion option to a user, the venue promotion option including a list of venues where information concerning auction listings can be displayed;
receiving instructions from the user, the instructions containing a selection of the venue.

25. The method of claim 22, wherein the at least one auction listing is a plurality of auction listings, each of the plurality of auction listings listed on a listing page of the website of the auction firm; the method further comprising:
providing free limited internet access at the venue, wherein
the free limited internet access is limited to particular web pages, and
at least some of the particular web pages are the listing pages of the website of the auction firm corresponding to the plurality of auction listings.

26. The method of claim 22, further comprising:
providing a website which contains the information regarding the plurality of auction listings displayed during a particular time period.

27. The method of claim 26, wherein the particular time period is a day.

28. The method of claim 26, further comprising:
providing links on the website to the each of the listing pages corresponding to the information regarding the plurality of auction listings displayed in the venue during the particular time period.

29. The method of claim 22, wherein the at least one auction listing is a plurality of auction listings, each of the plurality of auction listings listed on a listing page of the website of the auction firm; the method further comprising:
dynamically rotating the presentation of information regarding each of the plurality of auction listings, the information regarding each of the plurality of auction listings displayed for at a least a specified time period.

30. The method of claim 29, further comprising:
dynamically rotating a display of an advertisement and venue content with the information regarding the plurality of auction listings, the venue content comprising a logo or brand of the venue.

31. The method of claim 30, further comprising:
determining a schedule for rotation of the advertisement, the venue content, and the information regarding the plurality of auction listings.

32. The method of claim 29, wherein
the venue is a venue group comprising a plurality of venues, and
the information regarding the plurality of auction listings is displayed in each of the plurality of venues.

33. The method of claim 29, further comprising:
acquiring at least a portion of the information regarding the plurality of auction listings from the auction firm;
formatting the information regarding the plurality of auction listings for display at the venue; and
communicating the information regarding the plurality of auction listings to the venue through the communication network.

34. The method of claim 29, further comprising:
receiving a bid on one of the plurality of auction listings from a patron at the venue, the receipt of the bid tied to at least some of the information regarding the plurality of auction listings.

35. The method of claim 34, wherein the bid is received from a wireless phone.

36. The method of claim 35, wherein the bid is received from a Short Message Service (SMS) message communicated from the wireless phone.

37. The method of claim 35, wherein the bid is received from Dual Tone Multi-Frequency (DTMF) signals communicated from the wireless phone, the DTMF signals recognizable by a processor.

38. The method of claim 34, wherein the bid is received from a wireless laptop.

39. The method of claim 38, wherein the bid is communicated from the wireless laptop using a Wireless Application Protocol (WAP).

40. The method of claim 34, wherein the bid is received from a wireless PDA.

41. The method of claim 34, wherein the bid is received from a telephone.

42. The method of claim 41, wherein the bid is received from Dual Tone Multi-Frequency (DTMF) signals communicated from the telephone, the DTMF signals recognizable by a processor.

43. A system for promoting auction listings in a venue, the system comprising:
a controller for receiving information regarding at least one auction listing from a communication network, the at least one auction listing listed on a listing page of a website of an auction firm; and
a display, located at a venue where people congregate and communicatively coupled to the controller, the display operable to display the information regarding the at least one auction listing to at least one patron of the venue who did not request to view the information regarding at least one auction listing.

44. The system of claim 43, wherein the communicative coupling between the display and the controller is at least partially wireless.

45. The system of claim 43, the system further comprising:
a content intermediary component, operable to:
acquire at least a portion of the information regarding the at least one auction listing from the auction firm;
format the information regarding the at least one auction listing for display at the venue; and
communicate the information regarding the at least one auction listing to the venue through the communication network.

46. A method of promoting auction listings listed on listing pages of a website of an auction firm, the method comprising:
providing free limited internet access at a venue where people congregate, wherein
the free limited internet access is limited to particular web pages, and
at least some of the particular web pages are the listing pages of the website of the auction firm corresponding to the auction listings.

47. The method of claim 46, wherein the at least some of the particular web pages are additionally accessible through paid internet access.

48. The method of claim 46, further comprising:
receiving instructions from a user to display the auction listings in a particular venue, wherein the free limited internet access is provided in the particular venue.

49. The method of claim 48, wherein at least one of the particular web pages is a website with links to the listing pages for each of the auction listings requested to be displayed at the particular venue.
